(19) United States
(12) Patent Application Publication
(10) Pub. No.: US 2026/0360000 A1
(43) Pub. Date: Nov. 12, 2026

(54) Imaging Device

(71) Applicant: Astemo, Ltd., Chiyoda-ku, Tokyo (JP)

(72) Inventors: Naoya TADA, Hitachinaka-shi, Ibaraki (JP); Maho HORINAGA, Hitachinaka-shi, Ibaraki (JP); Jumpei KUNITAKE, Hitachinaka-shi, Ibaraki (JP); Hiroto MITOMA, Hitachinaka-shi, Ibaraki (JP)

(21) Appl. No.: 19/515,833

(22) PCT Filed: Dec. 11, 2023
(86) PCT No.: PCT/JP2023/044168

§ 371 Date: Mar. 3, 2026

(51) Int. Cl. G06T 7/593; G06T 5/80; G06T 7/60

(52) U.S. Cl. CPC G06T 7/593; G06T 5/80; G06T 7/60; G06T 2207/10012

(57) ABSTRACT

A task of the present invention is to provide an imaging device capable of correctly correcting a parallax disparity during traveling. An imaging device (10) according to the present invention is an imaging device (10) that images a first target (21) and a second target (22) of a preceding vehicle (200) and corrects a parallax disparity. The imaging device includes: a first imaging unit (11); a second imaging unit (12); a first parallax calculation unit (13) that calculates a first parallax based on an image of the first target captured by the first imaging unit and an image of the first target captured by the second imaging unit; and a second parallax calculation unit (14) that calculates a second parallax based on the image of the first target captured by the first imaging unit and the image of the second target captured by the second imaging unit; a virtual baseline length calculation unit (15) that calculates a virtual baseline length using the first parallax, the second parallax, and the baseline length; and a correction unit (16) that corrects a parallax disparity based on the virtual baseline length.

### TECHNICAL FIELD

The present invention relates to an imaging device.

### BACKGROUND ART

PTL 1 describes “an image processing device that recognizes 3-dimensional position information of a subject based on a pair of pieces of image data obtained by executing imaging in a traveling direction of a self-vehicle using a stereo camera, the image processing device including a vehicle detection processing unit 1d that detects positions of a pair of brake lamps on the pair of pieces of image data and a parallax offset value correction processing unit le that corrects a calculation formula for calculating a distance to the subject based on a parallax of the brake lamps and the number of separated pixels of the pair of right and left brake lamps at two points having different distances in the traveling direction.”

### CITATION LIST

### Patent Literature

PTL 1: JP 2017-009388 A

### SUMMARY OF INVENTION

### Technical Problem

When a parallax correction technique of a stereo camera is applied in emerging countries in South East Asia, there is concern that the parallax correction technique for correcting a parallax disparity does not work sufficiently during traveling due to poor road environment or the like. In the parallax correction technique of the related art, presence of white lines on both sides of a road and a brake lamp (BL) during lighting of a preceding vehicle are used, but in a road environment or a crowded traveling environment in Asia, the information cannot be sufficiently used.

The present invention has been made in view of the above circumstances and an object of the present invention is to provide an imaging device capable of correctly correcting a parallax disparity during traveling.

### Solution to Problem

To solve the above problem, an imaging device according to the present invention images first and second targets at positions separated by equal distances from first and second targets of an object and corrects a parallax disparity. The imaging device includes: a first imaging unit; a second imaging unit paired with the first imaging unit and disposed at a position separated by a given distance in a direction intersecting a direction oriented toward the object; a first parallax calculation unit configured to calculate a first parallax of the first target based on a position of the first target on the image captured by the first imaging unit and a position of the first target on the image captured by the second imaging unit; a second parallax calculation unit configured to calculate a second parallax that is a parallax between the first and second targets based on the position of the first target on the image captured by the first imaging unit and the position of the second target on the image captured by the second imaging unit; a virtual baseline length calculation unit configured to calculate a virtual baseline length that is a length obtained by adding a baseline length to a separation distance between the first and second targets using the first parallax, the second parallax, and a baseline length that is a separation distance between the first and second imaging units; and a correction unit configured to correct a parallax disparity between the first and second imaging units based on the virtual baseline length.

### Advantageous Effects of Invention

According to the present invention, it is possible to obtain an imaging device capable of correctly correcting a parallax disparity during traveling.

Further features according to the present invention will become apparent from description of the present specification and the accompanying drawings. Problems, configurations, and effects other than those described above will be clarified by the following description of embodiments.

### BRIEF DESCRIPTION OF DRAWINGS

FIG. 1 is a functional block diagram illustrating an imaging device according to a first embodiment of the present invention.

FIG. 2 is a flowchart illustrating a parallax disparity correction method by the imaging device according to the first embodiment.

FIG. 3 is a diagram illustrating a first parallax.

FIG. 4 is a diagram illustrating a second parallax.

FIG. 5 is a diagram illustrating a distance measurement principle and a virtual baseline length of a stereo camera.

FIG. 6 is a schematic diagram illustrating an example in which an imaging device is mounted in a vehicle.

FIG. 7 is a diagram illustrating a positional relationship between a self-vehicle and a preceding vehicle at first and second imaging time points.

FIG. 8 is a flowchart illustrating a parallax disparity correction method by an imaging device according to a second embodiment.

FIG. 9 is a flowchart illustrating a parallax disparity correction method by the imaging device according to the second embodiment.

FIG. 10 is a flowchart illustrating a parallax disparity correction method by the imaging device according to the second embodiment.

FIG. 11 is a diagram illustrating a method of calculating the number of pixels for a baseline length in the imaging device according to the second embodiment.

FIG. 12 is a diagram illustrating a method of calculating a distance between left and right rear tires of a preceding vehicle in an imaging device according to the second embodiment.

### DESCRIPTION OF EMBODIMENTS

Next, embodiments of the present invention will be described with reference to the drawings.

### First Embodiment

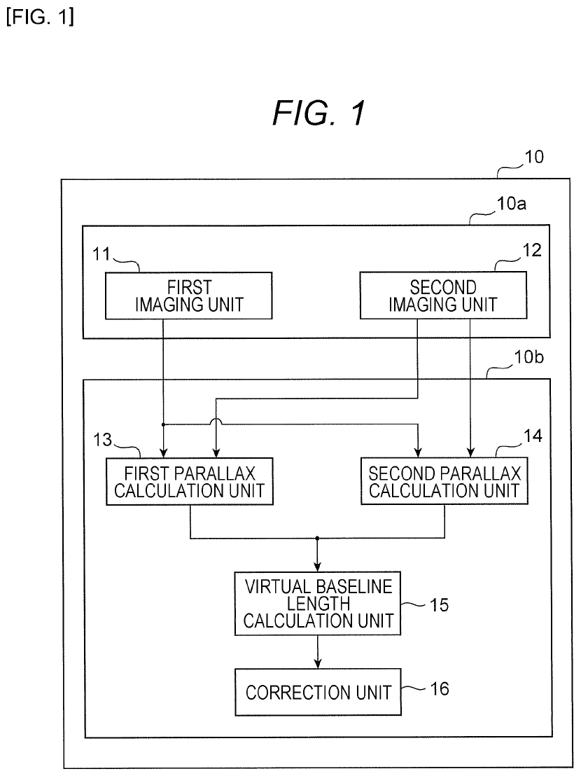

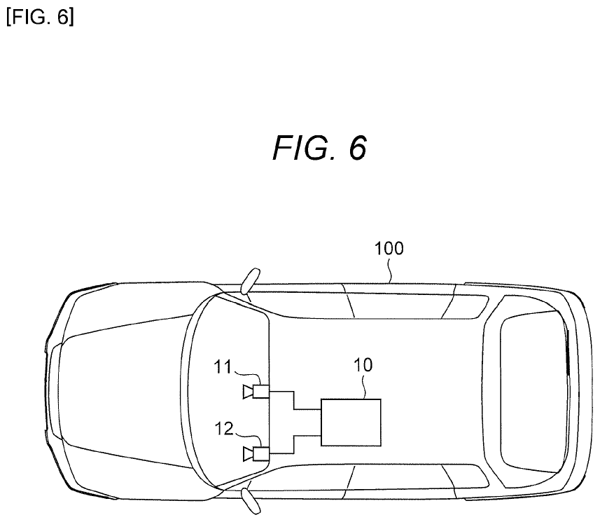

FIG. 1 is a functional block diagram illustrating an imaging device according to a first embodiment of the present invention. FIG. 6 is a schematic diagram illustrating an example in which the imaging device is mounted in a vehicle.

As illustrated in FIG. 1, an imaging device 10 includes an imaging unit 10a and a control unit 10b that processes an image captured by the imaging unit 10a. As illustrated in FIG. 6, the imaging device 10 is mounted in a vehicle 100 (hereinafter also referred to as a self-vehicle 100). The imaging device 10 is a stereo camera that images the front of a vehicle through a windshield, and includes a pair of left and right imaging units 11 and 12 as the imaging unit 10a. The pair of left and right imaging units 11 and 12 are disposed separated from each other in a vehicle width direction, and can image an area overlapping with each other in front of the self-vehicle 100 and an object such as a preceding vehicle 200 traveling in the same direction in front of the vehicle.

In the present embodiment, the first imaging unit 11 between the pair of left and right imaging units 11 and 12 is disposed at the center in the vehicle width direction. Then, the second imaging unit 12 is disposed in a direction intersecting a direction oriented toward the object, specifically, at a position separated from the first imaging unit 11 on the left side in the vehicle width direction by a given distance.

For example, the control unit 10b of the imaging device 10 performs image processing on images captured by the pair of left and right imaging units 11 and 12 to detect an object and recognize a type of object. Information regarding results of detection of the object and recognition of the type of object is used for automatic driving (AD) and advanced driver assistance system (ADAS) of the vehicle 100.

Then, the control unit 10b of the imaging device 10 corrects a parallax disparity during traveling. The parallax disparity is a parallax error and occurs due to, for example, a deviation between optical axes of the left and right imaging units 11 and 12. The control unit 10b of the imaging device 10 images first and second targets at positions separated by equal distances from the first and second targets of the object, and corrects the parallax disparity between the left and right imaging units 11 and 12. The parallax disparity is corrected through control processing in the control unit 10b using a correction value.

The imaging device 10 images the preceding vehicle 200 as an object, images left and right rear tires 21 and 22 of the preceding vehicle 200 as the first and second targets, and corrects a parallax disparity. The left and right rear tires 21 and 22 of the preceding vehicle 200 are considered to be present at positions separated from the vehicle 100 by an equal distance. In the present embodiment, the imaging device 10 images the same preceding vehicle 200 twice with a time difference, and corrects the parallax disparity based on the difference.

The control unit 10b of the imaging device 10 includes an electronic control unit (ECU) including a central processing unit (CPU), a storage unit (RAM or ROM), and an input/output unit (I/O interface), and implements various functions by reading a dedicated software program installed in the storage device and executing the program in the central processing unit. The control unit 10b includes a first parallax calculation unit 13, a second parallax calculation unit 14, a virtual baseline length calculation unit 15, and a correction unit 16 as internal functions.

The first parallax calculation unit 13 performs processing for calculating a first parallax w1 [pix] of the first target based on a position of the first target on the image captured by the first imaging unit 11 and a position of the first target on the image captured by the second imaging unit 12. For example, the first parallax calculation unit 13 calculates the first parallax w1 [pix] of the first target by template matching using the image captured by the first imaging unit 11 as a standard image and using the image captured by the second imaging unit 12 as a reference image.

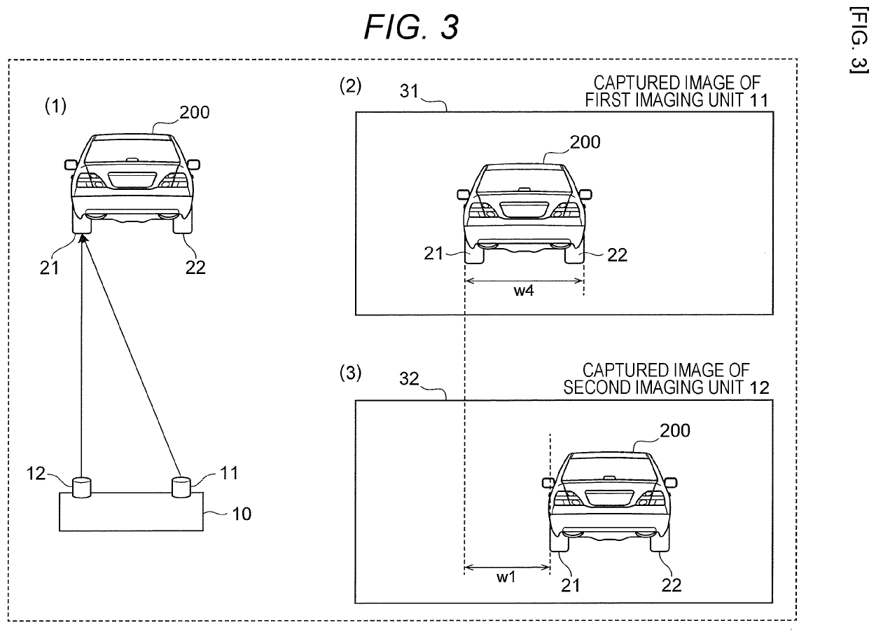

FIG. 3 is a diagram illustrating a first parallax. As illustrated in (1) of FIG. 3, when the preceding vehicle 200 is captured by the first imaging unit 11 and the second imaging unit 12 of the imaging device 10, positions at which the preceding vehicle 200 is imaged deviate to the left and right in an image 31 of the first imaging unit 11 illustrated in (2) of FIG. 3 and an image 32 of the second imaging unit 12 illustrated in (3) of FIG. 3. The first parallax w1 [pix] is generated between a position of the left rear tire (hereinafter also referred to as a first target) 21 captured in the image 31 of the first imaging unit 11 and a position of the first target 21 captured in the image 32 of the second imaging unit 12.

The second parallax calculation unit 14 performs processing for calculating a second parallax w2 [pix] that is a parallax between the first target 21 and the second target 22 based on a position of the first target 21 on the image captured by the first imaging unit 11 and a position of the right rear tire (hereinafter also referred to as a second target) 22 on the image captured by the second imaging unit 12. For example, the second parallax calculation unit 14 calculates the second parallax w2 [pix] by template matching using the image captured by the first imaging unit 11 as a standard image and using the image captured by the second imaging unit 12 as a reference image.

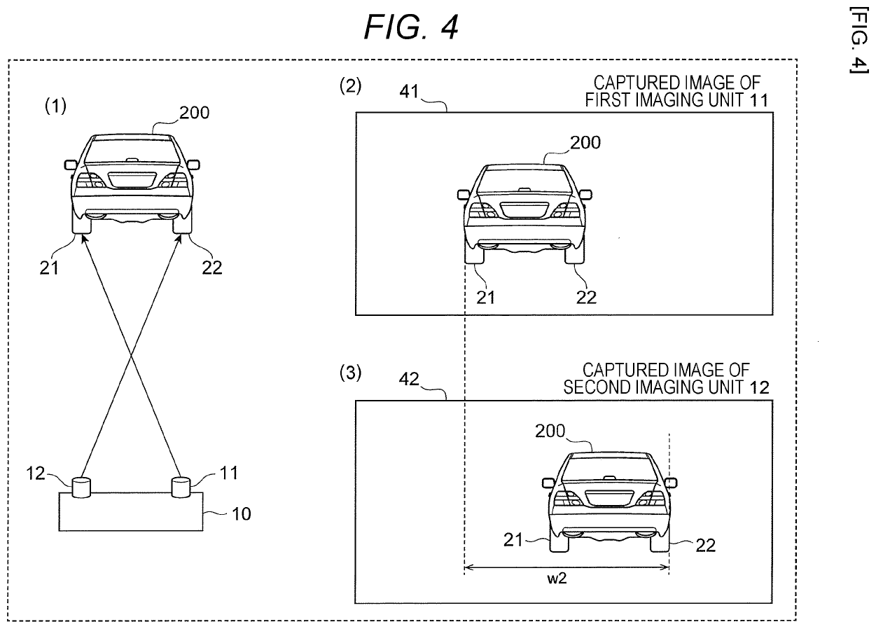

FIG. 4 is a diagram illustrating the second parallax. As illustrated in (1) of FIG. 4, when the preceding vehicle 200 is imaged by the first imaging unit 11 and the second imaging unit 12 of the imaging device 10, positions at which the preceding vehicle 200 is imaged deviate to the left and right in an image 41 of the first imaging unit 11 illustrated in (2) of FIG. 4 and an image 42 of the second imaging unit 12 illustrated in (3) of FIG. 4. The second parallax w2 [pix] is defined between the position of the left rear tire 21 that is the first target captured in the image 41 of the first imaging unit 11 and the position of the right rear tire 22 that is the second target captured in the image 42 of the second imaging unit 12.

The virtual baseline length calculation unit 15 calculates a virtual baseline length B2 [mm] that is a length obtained by adding the baseline length B1 [mm] to the separation distance x [mm] between the first target 21 and the second target 22 by using the first parallax w1 [pix], the second parallax w2 [pix], and the baseline length B1 [mm] that is the separation distance between the first imaging unit 11 and the second imaging unit 12. A value of the baseline length B1 [mm] is stored in advance in the control unit 10b.

The correction unit 16 corrects the parallax disparity between the first imaging unit 11 and the second imaging unit 12 based on the virtual baseline length B2 [mm]. In the present embodiment, a correction value a for correcting the parallax disparity is calculated based on the first virtual baseline length B2 t1 [mm] that is a virtual baseline length at a first imaging time point t1 and the second virtual baseline length B2 t2 [mm] that is a virtual baseline length at a second imaging time point t2.

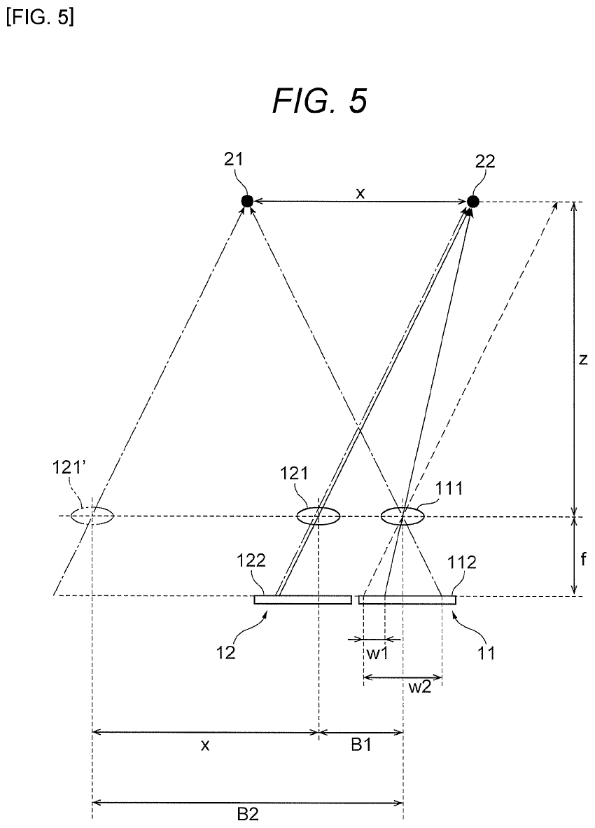

FIG. 5 is a diagram illustrating a distance measurement principle and a virtual baseline length of the stereo camera.

In the present embodiment, it is assumed that distances z [mm] in an optical axis direction from the first imaging unit 11 and the second imaging unit 12 to the left and right rear tires 21 and 22 of the preceding vehicle 200 are the same. As illustrated in FIG. 5, the imaging unit 10a of the imaging device 10 includes lenses 111 and 121 of the first imaging unit 11 and the second imaging unit 12, and image sensors (for example, COMS elements) 112 and 122 of the first imaging unit 11 and the second imaging unit 12. The imaging unit 10a sets focal lengths of the lenses 111 and 121 to f [mm].

In the example illustrated in FIG. 5, a distance in the optical axis direction from the lenses 111 and 121 to the left and right rear tires 21 and 22 of the preceding vehicle 200 is z [mm], and a separation distance between the left and right rear tires 21 and 22 of the preceding vehicle 200 is x [mm]. A separation distance between the left and right imaging units 11 and 12 is defined as the baseline length B1 [mm], and a length obtained by adding the separation distance x [mm] between the left and right rear tires 21 and 22 to the baseline length B1 [mm] is defined as the virtual baseline length B2 [mm].

When no parallax disparity is generated, the first parallax w1 [pix] and the second parallax w2 [pix] are obtained by the following Formulas (1) and (2).

w1=(f×B1)/(z) (1)

w2=(f×B2)/(z) (2)

From Formula (1)

z=(f×B1)/(w1) (3)

From Formula (2)

B2=(w2×z)/(f) (4)

When Formula (3) is substituted into Formula (4),

B2=(w2)×((f×B1)/(w1))/(f)=B1×(w1/w2) (5)

The baseline length B1 [mm] and the virtual baseline length B2 [mm] are fixed values, and do not change even when the distance z [mm] between the self-vehicle 100 and the preceding vehicle 200 changes depending on an imaging time point. Accordingly, when the parallax disparity is not generated, the virtual baseline length B2 [mm] does not change despite the change in the distance z [mm]. For example, a result (6) of calculating the virtual baseline length B2 (10 m) at z=10 meters [m] and a result (7) of calculating the virtual baseline length B2 (20 m) at z=20 meters [m] have a relationship of (6) B2 (10 m)=(7) B2 (20 m).

Conversely, when a parallax disparity Δw is generated,
the first parallax w1 [pix] and the second parallax w2 [pix] are expressed by the following Formulas (1′) and (2′).

w1+Δw=(f×B1)/(z) (1′)

w2+Δw=(f×B2)/(z) (2′)

From Formula (1′)

z=(f×B1)/(w1+Δw) (3′)

From Formula (2′)

B2=((w2+Δw)×z)/(f) (4′)

When Formula (3′) is substituted into Formula (4′),

B2=(w2+Δw)×((f×B1)/(w1+Δw))/(f)=B1×((w1+Δw)/(w2+Δw)) (5′)

In a situation where a parallax disparity is generated, for example, a result (6′) of calculating the virtual baseline length B2 (10 m) at z=10 meters [m] and a result (7′) of calculating the virtual baseline length B2 (20 m) at z=20 meters [m] are not the same but have a relationship of (6′)≠(7′).

In the present embodiment, when the relationship of (6′)≠(7′) is held, the correction value a in which the relationship of (6′)≠(7′) is held is set using the following Formula (8).

B2=B1×(w2+Δw+α)/(w1+Δw+α) (8)

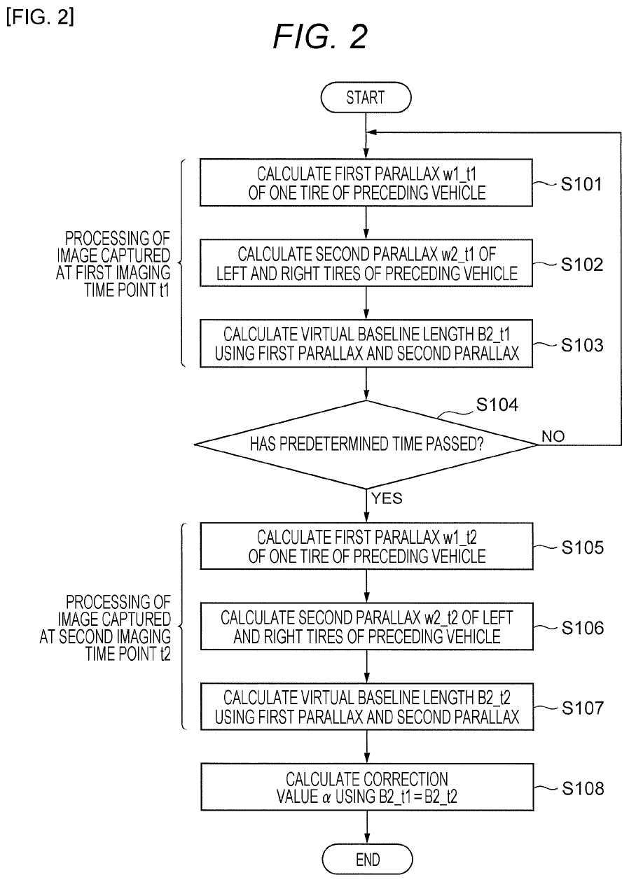

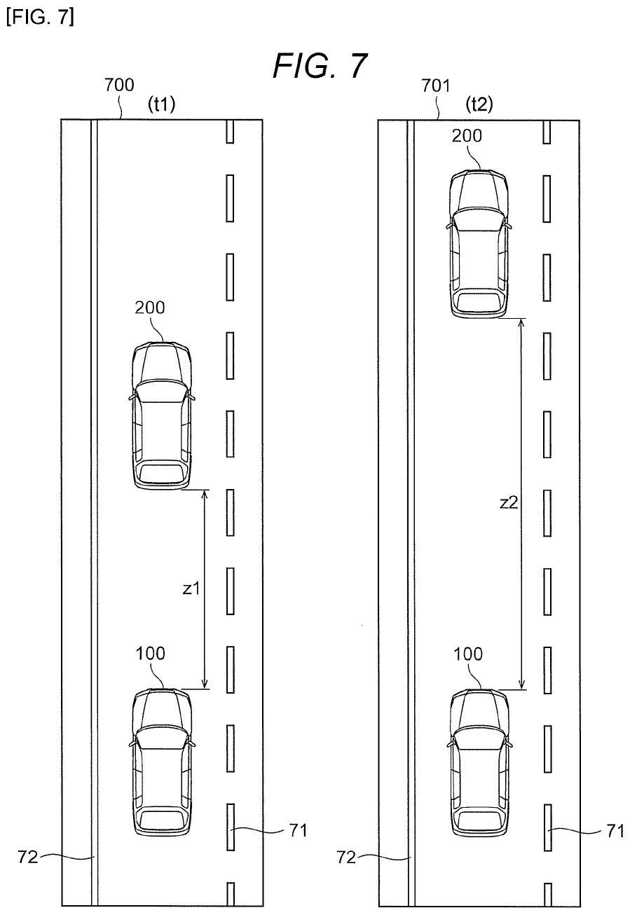

FIG. 2 is a flowchart illustrating a parallax disparity correction method by the imaging device according to the first embodiment. FIG. 7 is a diagram illustrating a positional relationship between the self-vehicle and the preceding vehicle at the first and second imaging time points. Reference numeral 700 in FIG. 7 denotes a situation in which the self-vehicle 100 is traveling on a travel lane sandwiched between a white line 71 and a roadside strip 72, and the preceding vehicle 200 is traveling in front of the self-vehicle at an interval z1. Reference numeral 701 denotes a situation in which the preceding vehicle 200 is traveling in front of the self-vehicle 100 at an interval z2.

The processing of S101 to S103 in FIG. 2 is processing of an image captured at the first imaging time point t1 under the situation indicated by reference sign 700 in FIG. 7, and the processing of S105 to S108 is processing of an image captured at the second imaging time point t2 under the situation indicated by reference sign 701 in FIG. 7. At the first imaging time point t1, a distance between the self-vehicle 100 and the preceding vehicle 200 is z1. At the second imaging time point t2, the distance between the self-vehicle 100 and the preceding vehicle 200 increases to z2.

The first parallax calculation unit 13 calculates the first parallax w1_t1 [pix] at the first imaging time point t1 (S101), and the second parallax calculation unit 14 calculates the second parallax w2_t1 [pix] at the first imaging time point t1 (S102).

The virtual baseline length calculation unit 15 calculates the first virtual baseline length B2 t1 [nm] using the first parallax w1_t1 [pix] at the first imaging time point t1, the second parallax w2_t1 [pix] at the first imaging time point t1, and the baseline length B1 [mm] (S103).

Then, it is determined whether a predetermined time has passed from the first imaging time point t1 (S104). When it is determined that the predetermined time has passed (YES in S104), the processing proceeds to processing of an image captured at the second imaging time point t2. In the present embodiment, it is assumed that an inter-vehicle distance between the self-vehicle 100 and the preceding vehicle 200 changes since the predetermined time has passed from the first imaging time point t1, and imaging is performed using this time point as the second imaging time point t2. The distance z to the preceding vehicle 200 may be measured, and a time point at which a change in the inter-vehicle distance is detected from the first imaging time point t1 may be set as the second imaging time point t2.

The first parallax calculation unit 13 calculates the first parallax w1_t2 [pix] at the second imaging time point t2 (S105), and the second parallax calculation unit 14 calculates the second parallax w2_t2 [pix] at the second imaging time point t2 (S106).

The virtual baseline length calculation unit 15 calculates the second virtual baseline length B2_t2 [mm] using the first parallax w1_t2 [pix] at the second imaging time point t2, the second parallax w2_t2 [pix] at the second imaging time point t2, and the baseline length B1 [mm] (S107).

The correction unit 16 calculates the correction value a for making the first virtual baseline length B2_t1 [mm] and the second virtual baseline length B2_t2 [mm] equal (S108).

In the imaging device 10 according to the present embodiment, the first parallax calculation unit 13 calculates the first parallax w1_t1 [pix] at the first imaging time point t1 and the first parallax w1_t2 [pix] at the second imaging time point t2, and the second parallax calculation unit 14 calculates the second parallax w2_t1 [pix] at the first imaging time point t1 and the second parallax w2_t2 [pix] at the second imaging time point t2.

Then, the virtual baseline length calculation unit 15 calculates the first virtual baseline length B2_t1 [mm] using the first parallax w1_t1 [pix] at the first imaging time point t1, the second parallax w2_t1 [pix] at the first imaging time point t1, and the baseline length B1 [mm], and calculates the second virtual baseline length B2_t2 [mm] using the first parallax w1_t2 [pix] at the second imaging time point t2, the second parallax w2_t2 [pix] at the second imaging time point t2, and the baseline length B1 [mm]. The correction unit 16 sets, as the correction value a, a value for making the first virtual baseline length B2_t1 [mm] and the second virtual baseline length B2_t2 [mm] equal.

Next, functions and effects of the imaging device 10 according to the present embodiment will be described.

For example, as illustrated in FIG. 5, the baseline length B1 that is a separation distance between the first imaging unit 11 and the second imaging unit 12 is a fixed value, and a separation distance x between the left and right rear tires 21 and 22 is also a fixed value. Accordingly, when the parallax disparity is not generated in the imaging device 10, the virtual baseline length B2 calculated by Formula (5) using the first parallax w1, the second parallax w2, and the baseline length B1 does not change regardless of the distance z to the preceding vehicle 200.

Conversely, when the parallax disparity is generated in the imaging device 10, the virtual baseline length B2 calculated by Formula (5′) using the first parallax w1, the second parallax w2, the parallax error Δw, and the baseline length B1 changes according to the distance z to the preceding vehicle 200.

Accordingly, the virtual baseline lengths B2 are calculated at separation distances different from each other. The first virtual baseline length B2 t1 that is the virtual baseline length B2 at the first imaging time point t1 is compared with the virtual baseline length B2 t2 at the second imaging time point t2. When the virtual baseline lengths do not match each other, the correction value a in which the relationship of (6′)=(7′) is held can be set using the above Formula (8), and the parallax disparity can be corrected using the correction value α. The imaging device 10 according to the present embodiment can image, for example, the preceding vehicle 200 to correct the parallax disparity while the self-vehicle 100 is traveling.

### Second Embodiment

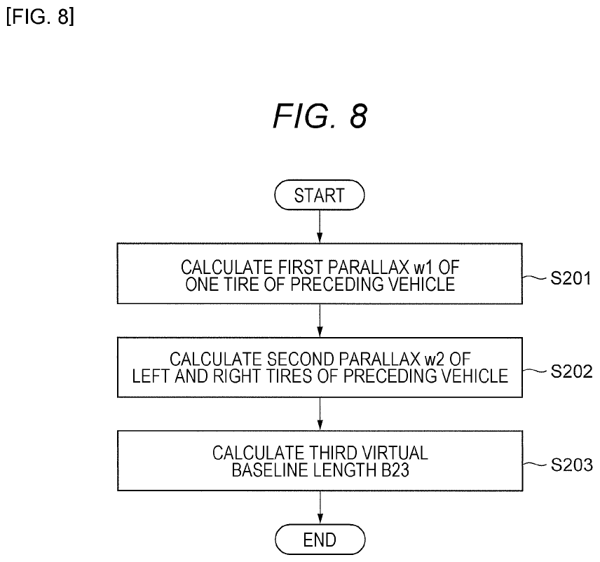

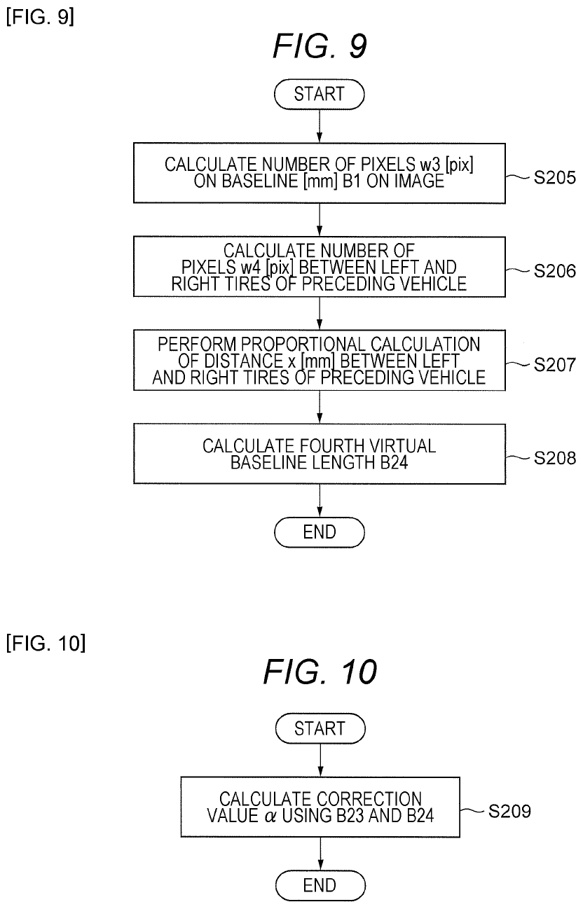

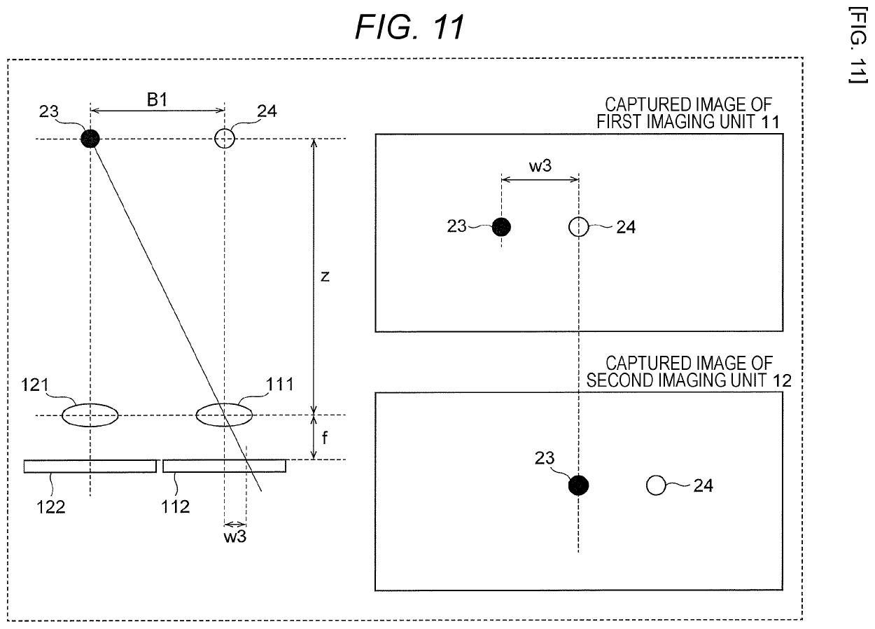

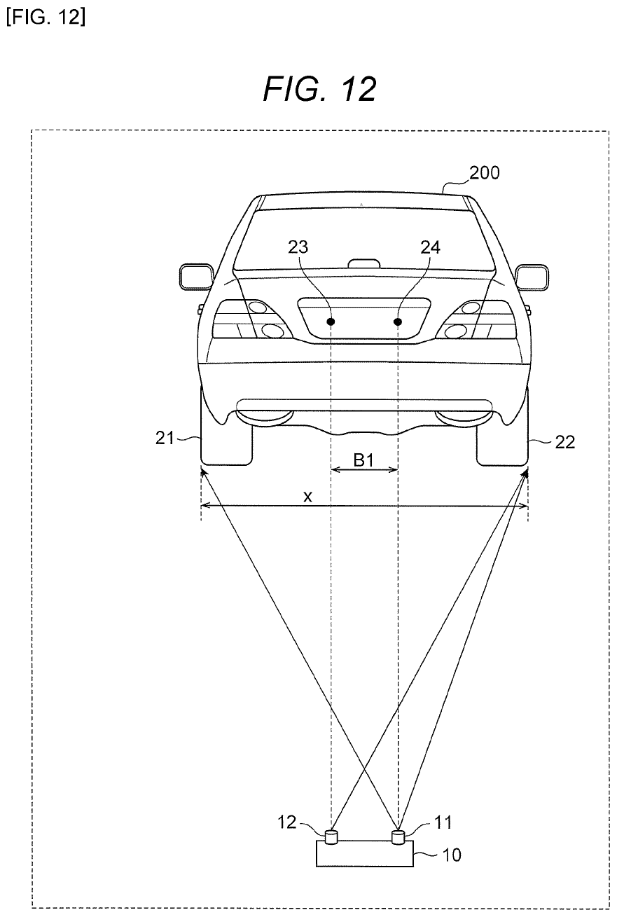

FIGS. 8 to 10 are flowcharts illustrating a parallax disparity correction method by an imaging device according to a second embodiment. FIG. 11 is a diagram illustrating a method of calculating the number of pixels for the baseline length in S205. FIG. 12 is a diagram illustrating a method of calculating a distance between left and right rear tires of a preceding vehicle in the imaging device according to the second embodiment. The same reference numerals are given to the same configurations as those of the first embodiment, and a detailed description thereof will be omitted.

A characteristic feature according to the present embodiment is that a correction value can be calculated only by measuring a parallax once without measuring the parallax a plurality of times at time intervals as in the first embodiment.

As in the first embodiment, the first imaging unit 11 and the second imaging unit 12 image the first target 21 and the second target 22 at positions separated by equal distances from the first target 21 and the second target 22 of the preceding vehicle 200.

The first parallax calculation unit 13 calculates the first parallax w1 [pix] based on the position of the first target 21 on the image captured by the first imaging unit 11 and the position of the first target 21 on the image captured by the second imaging unit 12 (S201). In the present embodiment, the first parallax w1 [pix] is calculated using the position of one tire of the preceding vehicle 200 as the position of the first target 21.

Then, the second parallax calculation unit 14 calculates the second parallax w2 [pix] based on the position of the first target 21 on the image captured by the first imaging unit 11 and the position of the second target 22 on the image captured by the second imaging unit 12 (S202). In the present embodiment, the second parallax w2 [pix] is calculated using the position of one tire of the preceding vehicle 200 as the position of the first target 21 and using the position of the other tire as the position of the second target 22.

The virtual baseline length calculation unit 15 calculates a third virtual baseline length B23 [mm] using the first parallax w1 [pix], the second parallax w2 [pix], and the baseline length B1 [mm] (S203). The third virtual baseline length B23 [mm] is a length obtained by adding the baseline length B1 [mm] to the separation distance x [mm] between the first target 21 and the second target 22. The processing from S201 to S203 is the same as the processing from S101 to S103 of the first embodiment.

Next, the virtual baseline length calculation unit 15 calculates the number of pixels w3 [pix] corresponding to the baseline length B1 on the image captured by the first imaging unit 11 or the second imaging unit 12 (S205). The virtual baseline length calculation unit 15 calculates the number of pixels w3 corresponding to the baseline length B1 based on a distance by which the target captured at the central position of the image captured by one of the first imaging unit 11 and the second imaging unit 12 is separated from the central position of the image captured by the other of the first imaging unit 11 and the second imaging unit 12.

For example, as illustrated in FIG. 12, both the third target 23 and the fourth target 24 of the preceding vehicle 200 are imaged by the first imaging unit 11 and the second imaging unit 12 by imaging the preceding vehicle 200. As illustrated in FIG. 11, the third target 23 is a target captured at the central position of the image of the second imaging unit 12, and the fourth target 24 is a target captured at the central position of the image of the first imaging unit 11.

In the image of the first imaging unit 11, the third target 23 is imaged at a position separated to the left from the fourth target 24 at the central position by the predetermined distance. This predetermined distance is a parallax of the third target 23 and is the number of pixels w3 [pix] corresponding to the baseline length B1 on the image captured by the first imaging unit 11 or the second imaging unit 12. That is, the number of pixels w3 [pix] corresponding to the baseline length B1 can be calculated by calculating the parallax of the third target 23. The parallax of the third target 23 is obtained by detecting the third target 23 captured in the image of the second imaging unit 12 to the third target 23 captured in the image of the first imaging unit 11, and by the number of pixels indicating a width that is the separation distance between the central position of the image of the first imaging unit 11 and the third target 23.

Next, the virtual baseline length calculation unit 15 calculates the number of pixels between the first target 21 and the second target 22, that is, the number of pixels w4 [pix] between the left and right rear tires 21 and 22 of the preceding vehicle 200 on the image captured by the first imaging unit 11 or the second imaging unit 12 (S206).

Then, by proportional calculation using the number of pixels w3 [pix] corresponding to the baseline length B1, the number of pixels w4 from the first target 21 to the second target 22, and the baseline length B1, a separation distance between the first and second targets 21 and 22, that is, the distance x [mm] between the left and right rear tires 21 and 22 of the preceding vehicle 200 is calculated by proportional calculation of the following Formula (9) (S207).

Number of pixels w3 [pix]:Number of pixels w4 [pix]=Baseline length B1 [mm]: Distance x [mm] (9)

Then, a fourth virtual baseline length B24 that is a length obtained by adding the baseline length B1 [mm] to the separation distance x [mm] between the first target 21 and the second target 22 is calculated (S208).

The correction unit 16 calculates the correction value a making the third virtual baseline length B23 [mm] and the fourth virtual baseline length B24 equal (S209). The correction unit 16 corrects the parallax disparity between the first imaging unit 11 and the second imaging unit 12 using the correction value a.

The imaging device 10 according to the present embodiment can calculate the correction value only by measuring the parallax once, and can correct the parallax disparity during traveling of the self-vehicle 100 without measuring the parallax a plurality of times at intervals of time as in the first embodiment.

Although the embodiments of the present invention have been described in detail above, the present invention is not limited to the above embodiments, and various design changes can be made without departing from the gist of the present invention described in the claims. For example, the above-described embodiments have been described in detail in order to describe the present invention in an easy-to-understand manner, and are not necessarily limited to those having all the described configurations. Some of the configurations of a certain embodiment can be replaced with configurations of another embodiment, and configurations of another embodiment can be added to the configurations of the certain embodiment. Furthermore, it is possible to add, delete, and replace other configurations for part of the configuration of each embodiment.

### REFERENCE SIGNS LIST

10 imaging device
11 first imaging unit
12 second imaging unit
13 first parallax calculation unit
14 second parallax calculation unit
15 virtual baseline length calculation unit
16 correction unit
100 self-vehicle
200 preceding vehicle (object)
B1 baseline length
B2 virtual baseline length
α Separation distance between left and right rear tires 21 and 22
correction value
w1 first parallax
w2 second parallax
z distance

1. An imaging device that images first and second targets at positions separated by equal distances from first and second targets of an object and corrects a parallax disparity, the imaging device comprising:
a first imaging unit;
a second imaging unit paired with the first imaging unit and disposed at a position separated by a given distance in a direction intersecting a direction oriented toward the object;
a first parallax calculation unit configured to calculate a first parallax of the first target based on a position of the first target on the image captured by the first imaging unit and a position of the first target on the image captured by the second imaging unit;
a second parallax calculation unit configured to calculate a second parallax that is a parallax between the first and second targets based on the position of the first target on the image captured by the first imaging unit and the position of the second target on the image captured by the second imaging unit;
a virtual baseline length calculation unit configured to calculate a virtual baseline length that is a length obtained by adding a baseline length to a separation distance between the first and second targets using the first parallax, the second parallax, and a baseline length that is a separation distance between the first and second imaging units; and
a correction unit configured to correct a parallax disparity between the first and second imaging units based on the virtual baseline length.

2. The imaging device according to claim 1, wherein the correction unit calculates a correction value for correcting the parallax disparity based on a first virtual baseline length that is a virtual baseline length at a first imaging time point and a second virtual baseline length that is a virtual baseline length at a second imaging time point.

3. The imaging device according to claim 2,
wherein the first parallax calculation unit calculates the first parallax at the first imaging time point and the first parallax at the second imaging time point,
wherein the second parallax calculation unit calculates the second parallax at the first imaging time point and the second parallax at the second imaging time point,
wherein the virtual baseline length calculation unit calculates the first virtual baseline length using the first parallax at the first imaging time point, the second parallax at the first imaging time point, and the baseline length, and calculates the second virtual baseline length using the first parallax at the second imaging time point, the second parallax at the second imaging time point, and the baseline length, and
wherein the correction unit sets, as a correction value, a value for making the first and second virtual baseline lengths equal.

4. The imaging device according to claim 1,
wherein the first parallax calculation unit calculates the first parallax by template matching using an image captured by the first imaging unit as a standard image and using an image captured by the second imaging unit as a reference image, and
wherein the second parallax calculation unit calculates the second parallax by template matching using the image captured by the first imaging unit as a standard image and using the image captured by the second imaging unit as a reference image.

5. The imaging device according to claim 1,
wherein the virtual baseline length calculation unit
calculates a third virtual baseline length that is a length obtained by adding the baseline length to a separation distance between the first and second targets using the first parallax, the second parallax, and the baseline length,
calculates the number of pixels corresponding to the baseline length on the image captured by the first or second imaging unit and the number of pixels between the first and second targets,
calculates a separation distance between the first and second targets by proportional calculation using the number of pixels corresponding to the baseline length, the number of pixels between the first and second targets, and the baseline length, and
calculates a fourth virtual baseline length that is a length obtained by adding the baseline length to a separation distance between the first and second targets, and
wherein the correction unit calculates a correction value for correcting the parallax disparity based on the third and fourth virtual baseline lengths.

6. The imaging device according to claim 5, wherein the virtual baseline length calculation unit calculates the number of pixels corresponding to the baseline length based on a distance by which a target captured at a central position of an image captured by one of the first and second imaging units is separated from a central position of an image captured by the other of the first and second imaging units.
